(19) United States
(12) Patent Application Publication
(10) Pub. No.: US 2023/0092011 A1
(43) Pub. Date: Mar. 23, 2023

(54) ECO-FRIENDLY AUTOMOTIVE INTERIOR PART AND METHOD OF MANUFACTURING SAME

(71) Applicants: HYUNDAI MOTOR COMPANY, Seoul (KR); KIA CORPORATION, Seoul (KR); H-BLUE., Ltd, Hwaseong-si (KR); DAE WON CHEMICAL CO., LTD., Seoul (KR)

(72) Inventors: Myoung Ryoul Lee, Seoul (KR); Gi Cheon Eom, Suwon-si (KR); Young Kyu Rhim, Hwaseong-si (KR); Woo Seung Shin, Seoul (KR)

(73) Assignees: HYUNDAI MOTOR COMPANY, Seoul (KR); KIA CORPORATION, Seoul (KR); H-BLUE., Ltd, Hwaseong-si (KR); DAE WON CHEMICAL CO., LTD., Seoul (KR)

(21) Appl. No.: 17/901,449

(22) Filed: Sep. 1, 2022

(30) Foreign Application Priority Data
Sep. 10, 2021 (KR) 10-2021-0120724

(51) Int. Cl. B32B 5/08; B32B 5/06; B32B 5/26; B32B 7/06; B32B 9/02; B32B 9/04; B32B 25/10; B32B 25/20; B32B 27/12; B32B 27/40; B32B 33/00; B32B 37/14; B32B 37/24; B32B 38/00

(52) U.S. Cl. CPC B32B 5/08; B32B 5/067; B32B 5/26; B32B 7/06; B32B 9/025; B32B 9/045; B32B 9/047; B32B 25/10; B32B 25/20; B32B 27/12; B32B 27/40; B32B 33/00; B32B 37/144; B32B 37/24; B32B 38/164; B32B 2037/243; B32B 2037/268

(57) ABSTRACT

Proposed are an eco-friendly automotive interior part, a method of manufacturing the same, and a method of designing the same automotive interior part. The automotive interior part can not only optimally correct physical properties thereof using manufacturing and design methods, but also have eco-friendliness by significantly reducing harmfulness to the human body due to the minimized use of chemicals, while realizing natural wrinkles resembling those of natural leather.

### CROSS REFERENCE TO RELATED APPLICATION

The present application claims priority to and benefit of Korean Patent Application No. 10-2021-0120724, filed Sep. 10, 2021, the entire contents of which is incorporated herein for all purposes by this reference.

### BACKGROUND

### Field

The present disclosure relates to an eco-friendly automotive interior part, a method of manufacturing the same, and a method of designing the same automotive interior part.

### Description of the Related Art

Nowadays, since people spend an increasingly long time in their automobiles due to changes in lifestyle, automotive interior parts are desired to be multifunctional and be value-added. In the case of automotive interior parts, since people can more easily recognize the quality differences among them compared to other general automotive parts, emotional and aesthetic factors are considered important.

It is desirable for automotive interior parts to have high flame retardancy, color fastness, strength, and durability suitable for the use thereof. Auxiliary characteristics such as antifouling and deodorizing properties and aesthetics are also desirable.

In line with the trend toward eco-friendliness, high quality, enhanced physical properties, and advanced functionality of automotive interior parts due to changes in the industrial environment and customers' desire for high-quality products, there is an increasing demand for leather-related products with luxurious appearance and sensation, enhanced physical properties, advanced functionality, harmlessness, eco-friendliness, and recyclability.

Nowadays, as leather for automotive interior parts, artificial leather products are widely used instead of natural leather. However, since organic solvents are used in the process for manufacturing artificial leather, toxic volatile organic compounds (VOCs) may be emitted from automotive interior products made of such artificial leather if the organic solvents are not completely removed through the post treatment of production of the artificial leather. In addition, a plasticizer added to improve flexibility has been found to generate odor and to be harmful to the human body, but there are few, if any, substitutes for the plasticizer. For this reason, the plasticizer causes problems of being harmful to the human body and of migrating to the surface of leather after long-term use, resulting in cracks.

The foregoing is intended merely to aid in the understanding of the background of the present disclosure, and is not intended to mean that the present disclosure falls within the purview of the related art that is already known to those having ordinary skill in the art.

### SUMMARY

Accordingly, the present disclosure has been made keeping in mind the above problems occurring in the related art. An objective of the present disclosure is to provide an automotive interior part including a regeneration composite layer including a regeneration layer and a physical property reinforcing layer disposed on the regeneration layer, a skin layer disposed on the physical property reinforcing layer of the regeneration composite layer, and a surface-modifying layer disposed on the skin layer.

Another objective of the present disclosure is to provide a method of manufacturing an automotive interior part, the method including preparing a regeneration layer, preparing a regeneration composite layer by laminating a physical property reinforcing layer on the regeneration layer, preparing an initial skin layer on release paper, preparing a laminate including a skin layer by laminating, on the physical property reinforcing layer of the regeneration composite layer, the initial skin layer on the release paper, followed by performing curing, removing the release paper, and coating a surface-modifying layer on the skin layer of the laminate.

Another objective of the present disclosure is to provide a method of designing an automotive interior part, the method including deriving a first set value by setting the thickness of a regeneration layer and a physical property reinforcing layer, deriving a second set value by setting the weight ratio of natural leather staple fibers and synthetic fibers contained in the regeneration layer, deriving a third set value by setting the structure of the physical property reinforcing layer, calculating the tensile strength of the automotive interior part from the first set value, the second set value, and the third set value, and correcting the thickness, weight ratio, and structure after the calculation.

In order to achieve the above objectives, according to one aspect of the present disclosure, there is provided an automotive interior part including, a regeneration composite layer including a regeneration layer and a physical property reinforcing layer disposed on the regeneration layer, a skin layer disposed on the physical property reinforcing layer of the regeneration composite layer, and a surface-modifying layer disposed on the skin layer.

The regeneration layer may be a layer in which natural leather staple fibers and synthetic fibers are entangled with each other.

The natural leather staple fibers and synthetic fibers may be mixed in a weight ratio of 60 to 99:1 to 40.

The physical property reinforcing layer may include at least one fiber selected from the group comprising or consisting of nylon, PET, PTT, PP, TC, linol, and cotton.

The physical property reinforcing layer may have at least one structure selected from the group comprising or consisting of woven fabric, nonwoven fabric, warp knit fabric, and circular knit fabric.

The regeneration layer may have a thickness in a range of 0.5 mm to 2.0 mm, and the physical property reinforcing layer may have a thickness in a range of 0.1 mm to 3.0 mm.

The regeneration composite layer may have a thickness in a range of 0.6 mm to 5.0 mm.

The skin layer may include at least one material selected from the group comprising or consisting of water-dispersible polyurethane (PU), solvent-free high solids, solvent-free polyurethane (PU), solvent-type polyurethane (PU), acrylic polyurethane resin, thermoplastic polyurethane (TPU), and silicone.

The skin layer may have a thickness in a range of 0.01 mm to 0.5 mm.

The surface-modifying layer may include a polyurethane resin and a gloss control agent.

A wet application amount of the surface-modifying layer may be equal to or less than 3.0 g/ft².

According another aspect of the present disclosure, there is provided an automotive interior part used for at least one purpose selected from the group comprising or consisting of automotive seats, door trims, consoles, crush pads, and steering wheels.

According to another aspect of the present disclosure, there is provided a method of manufacturing an automotive interior part, the method including preparing a regeneration layer, preparing a regeneration composite layer by laminating a physical property reinforcing layer on the regeneration layer, preparing an initial skin layer on release paper, preparing a laminate including a skin layer by laminating, on the physical property reinforcing layer of the regeneration composite layer, the initial skin layer on the release paper, followed by performing curing, removing the release paper, and coating a surface-modifying layer on the skin layer of the laminate.

The preparing of the regeneration layer may include preparing an initial regeneration layer by entangling natural leather staple fibers and polyester fibers with each other, performing primary drying to primarily remove moisture from the initial regeneration layer, removing hexavalent chromium from the initial regeneration layer from which moisture has been primarily removed, and performing secondary drying to secondarily remove moisture from the initial regeneration layer from which chromium has been removed.

The initial skin layer may have a thickness in a range of 0.01 mm to 0.5 mm.

The automotive interior part according to an embodiment may have eco-friendliness by significantly reducing harmfulness to the human body due to the minimized use of chemicals, and realize natural wrinkles resembling those of natural leather.

### BRIEF DESCRIPTION OF THE DRAWINGS

The above and other objectives, features, and other advantages of the present disclosure should be more clearly understood from the following detailed description when taken in conjunction with the accompanying drawings, in which:

FIG. 1 is a cross-sectional view illustrating an automotive interior part 1 according to an embodiment; and

FIG. 2 is a conceptual diagram illustrating a process of preparing an initial regeneration layer during a regeneration layer preparation step of a method of manufacturing an automotive interior part according to another embodiment.

### DETAILED DESCRIPTION

The above and other objectives, features, and other advantages of the present disclosure should become apparent with reference to the following description of embodiments. However, the present disclosure is not limited to the embodiments disclosed herein but may be implemented in various forms. The embodiments are provided by way of example only so that a person having ordinary skill in the art can fully understand the disclosures of the present disclosure and the scope of the present disclosure.

Like reference numerals refer to like components throughout the drawings. In the drawings, dimensions of structures are exaggerated for clarity. It should be understood that, although the terms first, second, and the like may be used herein to describe various elements, these elements should not be limited by these terms. These terms are only used to distinguish one element from another element. For example, a first element discussed below could be termed a second element without departing from the teachings of the present disclosure. Similarly, the second element could also be termed the first element. As used herein, the singular forms are intended to include the plural forms as well, unless the context clearly indicates otherwise.

It should be understood that the terms “comprise”, “include”, “have”, and the like, when used in this specification, specify the presence of stated features, integers, steps, operations, elements, components, and/or combinations of them but do not preclude the presence or addition of one or more other features, integers, steps, operations, elements, components, and/or combinations thereof. It should be further understood that when an element such as a layer, a film, a region, or a substrate is referred to as being “on” another element, it can be directly on the other element or intervening elements may also be present. In contrast, it should be understood that when an element such as a layer, a film, a region, or a substrate is referred to as being “under” another element, it can be directly under the other element or intervening elements may also be present.

Since all numbers, values and/or expressions referring to quantities of ingredients, reaction conditions, and the like, used herein and in the claims appended hereto, are subject to the various uncertainties of measurement encountered in obtaining such values, unless otherwise indicated, all are to be understood as modified in all instances by the term “about”. Where a numerical range is disclosed herein such range is continuous, inclusive of both the minimum and maximum values of the range as well as every value between such minimum and maximum values. Still further, where a range refers to integers, every integer between the minimum and maximum values of such range is included.

In this specification, where a range is stated for a parameter it should be understood that the parameter includes all values within the stated range, inclusive of the stated endpoints of the range. For example, a range of “5 to 10” should be understood to include the values 5, 6, 7, 8, 9, and 10 as well as any sub-range within the stated range, such as to include the sub-range of 6 to 10, 7 to 10, 6 to 9, 7 to 9, and the like, and inclusive of any value and range between the integers which is reasonable in the context of the range stated, such as 5.5, 6.5, 7.5, 5.5 to 8.5 and 6.5 to 9, and the like. For example, a range of “10% to 30%” should be understood to include the values 10%, 11%, 12%, 13%, and the like, and all integers up to 30% as well as any sub-range within the stated range, such as to include the sub-range of 10% to 15%, 12% to 18%, 20% to 30%, and the like, and inclusive of any value and range between the integers which is reasonable in the context of the range stated, such as 10.5%, 15.5%, 25.5%, and the like.

Artificial leather conventionally used as a material for automotive interior parts has a problem in which toxic volatile organic compounds (VOC) are emitted from the interior parts made of such artificial leather. Another problem is that an added plasticizer is harmful to the human body and migrates to the surface of leather, resulting in cracks.

To solve the above problems, the present inventors have studied diligently and found that when an automotive interior part is manufactured by including a regeneration composite layer composed of an eco-friendly regeneration layer and a physical property reinforcing layer positioned on the regeneration layer, a skin layer disposed on the physical property reinforcing layer of the regeneration composite layer, and a surface-modifying layer disposed on the skin layer, the use of chemicals is minimized, thereby making it possible to realize an automotive interior part that has eco-friendliness and has natural wrinkles resembling those of natural leather.

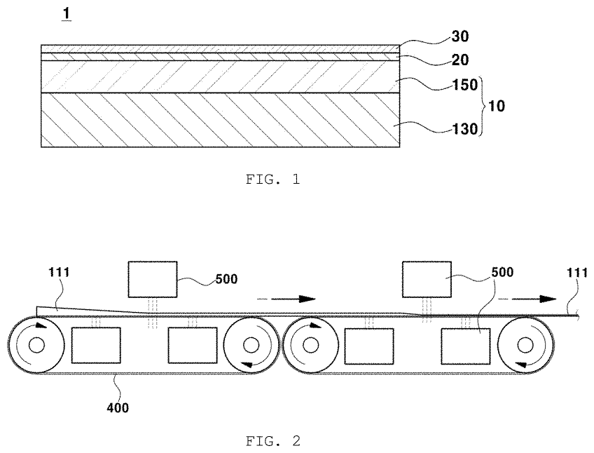

FIG. 1 is a cross-sectional view illustrating an automotive interior part 1 according to an embodiment. Referring to FIG. 1, the automotive interior part 1 includes a regeneration composite layer 10 including a regeneration layer 130 and a physical property reinforcing layer 150 disposed on the regeneration layer 130. The automotive interior part 1 also includes a skin layer 20 disposed on the physical property reinforcing layer 150 of the regeneration composite layer 10 and a surface-modifying layer 30 disposed on the skin layer 20.

The regeneration composite layer 10 may include the regeneration layer 130 and the physical property reinforcing layer 150 disposed on the regeneration layer 130.

The regeneration layer 130 is an eco-friendly and flame-retardant layer, and may be formed by entangling natural leather staple fibers and synthetic fibers (staple fibers).

In order to prepare the regeneration layer 130, first, natural leather staple fibers are prepared by pulverizing natural leather powder, scraps, by-products, or waste. For example, when the natural leather powder or the like is subjected to a beating process for, in one example, 60 to 120 minutes, microfibers are exposed, thereby obtaining natural leather staple fibers. Synthetic fibers are added to the natural leather staple fibers thus prepared and mixed together. The natural leather staple fibers may include staple fibers of animal skins. For example, the natural leather staple fibers may include staple fibers of at least one animal skin selected from the group comprising or consisting of cowhide, sheepskin, and pig skin. Staple fibers of cowhide are widely used, are hardly broken due to excellent durability and elasticity thereof, and have a high recovery rate. In addition, the synthetic fibers (staple fibers) may include at least one fiber selected from the group comprising or consisting of polyethylene terephthalate (PET), recycled PET, nylon, recycled nylon, PTT, PLA, PP, TC, linol, and other vegetable fibers. Polyethylene terephthalate (PET) fiber may be used as the staple fiber and is most often blended with natural fibers because of excellent elasticity, strength, shape stability, and low moisture absorption thereof.

The natural leather staple fibers and synthetic fibers may be mixed in a weight ratio of 60 to 99:1 to 40, and, in one example, 70 to 95:5 to 30. However, the weight ratio of fibers may be adjusted for product characteristics such as physical properties. When the weight ratio of the natural leather staple fibers is too low, the deterioration of eco-friendliness and flame retardancy performance may cause a problem in which the flammability rate exceeds 102 mm/min, which is a limit specified in the flammability regulations for the use of automotive interior materials. On the other hand, when the weight ratio of the natural leather staple fibers is too high, the bonding force or strength between the fibers is insufficient for use in automotive interior parts.

The mixed staple fibers form a web with a predetermined thickness, and may be subjected to a water jet process of entangling the fibers with water pressure. In other words, high-pressure water may be sprayed to the staple fibers so that the fibers are entangled with each other. This makes it possible to impart constant strength and elongation to the staple fibers. Such a water jet fiber entangling method using water pressure employs high-pressure water having a pressure of equal to or greater than 50 kg/cm²G, so it is very effective in avoiding damage to the fibers, and thus is advantageous for manufacturing expensive fabrics such as natural leather.

The thickness of the regeneration layer 130 satisfying the above characteristics is in a range of 0.5 mm to 2.0 mm.

In general, as a leather fabric used for covering automotive interior parts, a fabric with a thickness of equal to or greater than 0.5 mm is used. When the thickness of the fabric is less than 0.5 mm, surface irregularities may occur during covering. In addition, the regeneration layer 130 with a thickness of less than 0.5 mm has weak mechanical properties such as tensile strength and tear strength, and thus may be damaged by tension during manufacturing and may be difficult to be made into leather. When the thickness of the regeneration layer 130 exceeds 2.0 mm, insufficient bonding force between the fibers due to the water pressure of the water jet process may cause interlayer separation in the regeneration layer 130, which makes it difficult to prepare the regeneration layer 130.

The physical property reinforcing layer 150 may be a layer that is disposed on the regeneration layer 130 and serves to improve the tensile strength, tear strength, and elasticity of the automotive interior part 1 and to efficiently distribute stress. Accordingly, the physical property reinforcing layer 150 may include a material having desirable adhesion to the regeneration layer 130 and having flexible deformability. For example, the physical property reinforcing layer 150 may include a material having at least one fiber selected from the group comprising or consisting of nylon, PET, PTT, PP, TC, linol, and cotton. Each type of these fibers may have at least one structure, and, in one example, may have at least one structure selected from the group comprising or consisting of woven fabric, nonwoven fabric, warp knit fabric, and circular knit fabric. The thickness of the physical property reinforcing layer 150 is in a range of 0.1 mm to 3.0 mm. The physical property reinforcing layer 150 with a thickness of less than 0.1 mm is thin and low in strength, so the improvement in mechanical strength is insignificant. On the other hand, the physical property reinforcing layer 150 with a thickness of 3.0 mm is greatly improved in the mechanical strength, but it is thick and lacks flexibility, thereby increasing wrinkles.

In this case, the weight and rigidity of the automotive interior part 1 may be changed depending on the weight ratio according to the structure of individual fibers. For example, it is possible to combine weight ratios that correspond to the desired properties and quality, such as a woven fabric made of 100% nylon, a knit fabric made of 100% PET, a knit fabric made of 70% PET and 30% TC, and a nonwoven fabric made of 40% nylon, 30% PET, and 30% PP.

The thickness of the regeneration composite layer 10 including the regeneration layer 130 and the physical property reinforcing layer 150 satisfying the above characteristics is basically set to a range of 0.6 mm to 5.0 mm, and may be adjusted to a higher or lower level depending on other desired properties and quality. When the thickness of the regeneration composite layer 10 is too small, surface irregularities may occur when covering parts. On the other hand, when the thickness of the regeneration composite layer 10 is too large, as in the case of the physical property reinforcing layer 150, low flexibility may make it difficult to cover parts and increase wrinkles.

With such a configuration in which the regeneration composite layer 10 includes the regeneration layer 130 that is eco-friendly and harmless to the human body and the physical property reinforcing layer 150 that has an appropriate structure for each individual fiber type, the automotive interior part 1 according to an embodiment has eco-friendliness by significantly reducing harmfulness to the human body due to the minimized the use of chemicals, realizes natural wrinkles resembling those of natural leather, and properly secures mechanical properties.

In addition, the skin layer 20 may be a layer that is disposed on the physical property reinforcing layer 150 and serves to maintain an aesthetic appearance such as color and the like without discoloration. Therefore, it is desirable that the skin layer 20 have excellent heat resistance, light resistance, and moldability, and, in one example, includes an eco-friendly material. For example, the skin layer 20 may include at least one material selected from the group comprising or consisting of water-dispersible polyurethane (PU), solvent-free high solids, solvent-free polyurethane (PU), solvent-type polyurethane (PU), acrylic polyurethane resin, thermoplastic polyurethane (TPU), TPO, PVC, and silicone. In one case, water-dispersible polyurethane (PU) and solvent-free polyurethane (PU) may be used, which have very excellent VOC reduction performance.

In this case, as a polyol component constituting the polyurethane, i.e., the polyurethane resin, a polyol that controls the durability of polymer urethane during the polyurethane reaction and acts on heat resistance, hydrolysis resistance, and light resistance while determining elasticity and flexibility depending on the amount added may be used. For example, a biopolyol extracted from polyether polyol, polyester polyol, glycol, polycarbonate diol (PCD), sugar cane, plants, and the like, or a mixture thereof may be used. In one example, polycarbonate diol (PCD) having excellent strength and physical properties may be used.

The skin layer 20 may be a single layer or multilayer. When the skin layer 20 is a multilayer, this may advantageously help improve surface durability and prevent wrinkles.

In addition, the skin layer 20 may further include a foaming layer having porous cells and formed under the skin layer 20 by foaming. The foaming layer serves to improve volume, cushioning, and moldability, prevent surface damage, and improve durability. Examples of the foaming method may include air foaming, bead foaming, chemical foaming, and gas foaming. In one example, bead foaming is adopted for a stable cell structure, and capsule-type hollow microspheres used in the bead foaming may have a diameter of 10 μm to 200 μm and have a high softening point (170 degrees to 220 degrees) so as not to deformed by heat.

In addition, a plurality of protrusions may be formed on an upper surface of the skin layer 20. For example, the skin layer 20 may be subjected to a buffing process in which friction is generated on the upper surface of the skin layer 20 to form a nap. Specifically, in one example, a nubuck process may be performed in which the polyurethane skin layer 20 is passed through a roller wound with sandpaper so that a nap is formed on the surface of the polyurethane skin layer 20.

The thickness of the skin layer 20 may be in a range of 0.01 mm to 5.0 mm. However, the thickness of the skin layer 20 may be adjusted depending on the physical properties and application purposes. When the thickness of the skin layer 20 is too small, peeling may occur due to scratching, abrasion, and the like. On the other hand, when the thickness of the skin layer 20 is too large, flexibility may be deteriorated and the surface of the skin layer 20 may become dull.

The surface-modifying layer 30 may be a layer that is disposed on the skin layer 20 and serves to control gloss and texture or maintain a pattern shape. The surface-modifying layer 30 may include a polyurethane resin and a gloss control agent, and, in one example, water-dispersible polyurethane (PU) and a gloss control agent containing a polymer or a silica component imparting a matte or glossy sensation. In addition, a silicone additive, protein, and the like may be further added to adjust the surface texture, the squeak index, the surface friction coefficient, and the antifouling properties of the surface-modifying layer 30.

The wet application amount of the surface-modifying layer 30 may be equal to or less than 3.0 g/ft², and, in one example, in a range of 0.4 g/ft² to 0.8 g/ft². In addition, the thickness of the surface-modifying layer 30 may be equal to or less than 0.02 mm. However, the application amount may be adjusted depending on the physical properties of the product. When the application amount of the surface-modifying layer 30 is too small, gloss, texture, abrasion resistance, and antifouling properties may be deteriorated. On the other hand, when the application amount of the surface-modifying layer 30 is too large, the inherent pattern of natural leather is blurred and thus aesthetics and visibility may be deteriorated.

As described above, the automotive interior part 1 according to an embodiment minimizes the use of chemicals by using an eco-friendly material as the material of the layers, thereby reducing harmfulness to the human body and realizing natural wrinkles resembling those of natural leather.

Another embodiment provides a method of manufacturing an automotive interior part. The method includes preparing a regeneration layer, preparing a regeneration composite layer by laminating a physical property reinforcing layer on the regeneration layer to, preparing an initial skin layer on release paper, preparing a laminate including a skin layer by laminating, on the physical property reinforcing layer of the regeneration composite layer, the initial skin layer on the release paper, followed by performing curing, removing the release paper, and coating a surface-modifying layer on the skin layer of the laminate.

The method of manufacturing the automotive interior part may include content substantially overlapping with the content related to the above-described automotive interior part, and a description of the overlapping part may be omitted hereinafter.

The step of preparing the regeneration layer may specifically include preparing an initial regeneration layer by entangling natural leather staple fibers and polyester fibers with each other, performing primary drying to primarily remove moisture from the initial regeneration layer, removing hexavalent chromium from the initial regeneration layer from which moisture has been primarily removed, and performing secondary drying to secondarily remove moisture from the initial regeneration layer from which chromium has been removed.

FIG. 2 is a conceptual diagram illustrating a process of preparing an initial regeneration layer during a regeneration layer preparation step of a method of manufacturing an automotive interior part according to another embodiment. Referring to FIG. 2, the step of preparing the initial regeneration layer may be performed by preparing a web 111 in which cowhide staple fibers and polyester staple fibers are mixed, and then passing the web 111 between water jet sprayers 500. In this case, as illustrated in FIG. 2, while the web 111 may be moved through a conveyor belt 400, high-pressure water jets may be sprayed to the web 111 through a plurality of fine nozzles of the water jet sprayers 500 so that the fibers may be physically entangled with each other. For example, the plurality of water jet sprayers 500 may be disposed at positions corresponding to upper and lower portions of the web 111 (i.e., portions above and below the web 111 with respect to the conveyor belt 400), respectively, and the water jet sprayers 500 disposed at the upper and lower positions may be arranged to be offset from each other. Accordingly, the water jets may be evenly sprayed over the entire upper and lower surfaces of the web 111 by the water jet sprayers 500. This achieves uniform bonding between the fibers. As another example, the initial regeneration layer may be formed by stacking a plurality of webs 111 and then compressing the webs 111 by spraying high-pressure water jets to the webs 111. As another example, the initial regeneration layer may be formed by stacking the plurality of webs 111 and then compressing the webs 111 by re-passing the webs 111 between the water jet sprayers 500.

The step of performing primary drying is a step of primarily removing moisture from the initial regeneration layer. The primary drying may be performed by natural drying, dehydration with a vacuum pump, compression with a press, or heating with a heater. In this case, the drying temperature is in a range of 5° C. to 50° C., and the drying time is within 120 hours. In one example, the drying temperature is in a range of 20° C. to 25° C. and the drying time is 24 hours to 36 hours. It is also advantageous that the drying is performed in the shade without direct exposure to sunlight. When the drying conditions are out of the above range, deformation such as stiffening of the leather may occur and durability may be deteriorated.

The step of removing chromium is a step of removing hexavalent chromium from the initial regeneration layer from which moisture has been primarily removed. Specifically, the initial regeneration layer may be immersed in an aqueous reducing agent solution so that the reducing agent reacts with hexavalent chromium more rapidly to convert the same into trivalent chromium. Then, the initial regeneration layer immersed in the reducing agent may be washed with distilled water, after which the distilled water and the reducing agent converting hexavalent chromium into trivalent chromium may be mixed and removed. Therefore, it is possible to suppress and eliminate the conversion of the remaining trivalent chromium ions into hexavalent chromium ions.

The step of performing secondary drying is a step of secondarily removing moisture from the initial regeneration layer from which hexavalent chromium has been removed. Specifically, a part of moisture in the initial regeneration layer may be physically removed in advance, and then the remaining part of moisture may be finally removed by applying heat to the initial regeneration layer using a heater or the like.

As described above, the step of preparing the regeneration layer of the method of manufacturing automotive interior part according to the other embodiment is advantageous in that hexavalent chromium is removed without the use of chemicals harmful to the human body, and the regeneration layer is prepared in an eco-friendly manner by the use of a dry process.

The step of preparing the regeneration composite layer is a step of preparing the regeneration composite layer by laminating the physical property reinforcing layer on the regeneration layer. The lamination method may be a conventional method that can be used in the related art, for example, at least one method selected from the group comprising or consisting of chemical lamination, needle punching, water jet, hot melt, and an adhesive, but is not limited to a specific method.

The step of preparing the initial skin layer on the release paper is a step of preparing the initial skin layer by applying a compound for preparing the skin layer to the previously prepared release paper. The compound may be a composition for producing polyurethane, and specifically, may include a polyol component and an isocyanate component, and thus is, in one example, a water-dispersible polyurethane (PU) compound and/or a solvent-free polyurethane (PU) compound.

In this case, the thickness of the initial skin layer generated by applying and drying the compound is in a range of 0.01 mm to 0.5 mm. When the thickness of the initial skin layer is too small, surface durability may be deteriorated. On the other hand, when the thickness of the initial skin layer is too large, the drying time and curing time may be delayed, resulting in a deterioration in production efficiency, and the initial skin layer may be peeled off and loosened from the release paper during manufacture.

The step of preparing the laminate including the skin layer is a step of preparing the laminate including the skin layer by laminating the regeneration composite layer on the initial skin layer on the release paper and then performing curing. In this case, the curing temperature may be equal to or less than 170° C., and the curing time may be adjusted depending on reaction accelerators, but is, in one example, at least 12 hours. When the curing conditions are out of the above range, a bonding defect between the skin layer and the regeneration composite layer may occur, or the entire leather may be thermally deformed, or durability may be deteriorated.

The step of removing the release paper and the step of coating the surface-modifying layer on the skin layer of the laminate may be performed to finally manufacture the automotive interior part. Specifically, the release paper disposed on the uppermost surface of the laminate including the skin layer may be removed by curing, after which the surface-modifying layer may be coated on the upper surface from which the release paper has been removed. The surface-modifying layer may be coated by gravure or spray coating. As a result, the automotive interior part may be finally manufactured.

Another embodiment provides a method of designing an automotive interior part. The method includes deriving a first set value by setting the thickness of a regeneration layer and a physical property reinforcing layer, deriving a second set value by setting the weight ratio of natural leather staple fibers and synthetic fibers contained in the regeneration layer, deriving a third set value by setting the structure of the physical property reinforcing layer, calculating the tensile strength of the automotive interior part from the first set value, the second set value, and the third set value, and correcting the thickness, weight ratio, and structure after the calculation.

In one embodiment, in consideration of durability, the automotive interior part may have a tensile strength of equal to or greater than 20 kgf (based on a width of 3 cm) (measured by general measurement methods such as KS, ISO, ASTM, and the like). The tensile strength of artificial leather is largely governed by a fibrous layer under the skin layer. In the present disclosure, the fibrous layer is a regeneration composite layer in which the regeneration layer and the physical property reinforcing layer are combined. In order to obtain a tensile strength of equal to or greater than 20 kgf (based on a width of 3 cm), the tensile strength may be corrected by varying the thickness and structure of the physical reinforcing layer and the weight ratio of natural leather and synthetic fibers in the regeneration layer.

Specifically, a calculation method according to an embodiment is as follows.

The formula for the first set value is a thickness calculation formula, and each thickness may be calculated through Equations 1 and 2 below.

0.5≤A≤2.0, 0.1≤B≤3.0 <Equation 1>

0.6≤A+B≤5.0 [Equation 2]

A: regeneration layer thickness (mm), B: physical property reinforcing layer thickness (mm)

The formula for the second set value is a formula for the weight ratio in the regeneration layer, and the weight ratio may be calculated through Equation 3 below.

Weight ratio in regeneration layer=(2.5C+15D)/(C+D) <Equation 3>

C: natural leather staple fiber weight (g), D: PET fiber weight (g)

The natural leather staple fibers and synthetic fibers may be mixed in a weight ratio of 60 to 99:1 to 40, and, in one example, 70 to 95:5 to 30.

The formula for the third set value is a set formula according to the structure of the physical property reinforcing layer, and may be determined by Equation 4 below.

Select (α,β,γ,δ) <Equation 4>

α=10 (woven fabric coefficient), β=8 (nonwoven fabric coefficient), γ=12 (warp knit fabric coefficient), δ=7 (circular knit fabric coefficient), where the above coefficients are the coefficients according to the structure at the same fiber composition and the same weight.

The tensile strength among the calculated values may be calculated through Equation 5 below.

Tensile strength (kgf/3 cm)=A{(2.5C+15D)/(C+D)}+15B{Select (α,β,γ,δ)} <Equation 5>

A: regeneration layer thickness (mm), B: physical property reinforcing layer thickness (mm), C: natural leather staple fiber weight (g), D: synthetic fiber weight (g), α=(woven fabric coefficient)=8, μ=(nonwoven fabric coefficient), γ=(warp knit fabric coefficient), δ=(circular knit fabric coefficient)

When the calculated value obtained through the above calculation do not reach a target value of the tensile strength, the target value may be achieved through the calculation step.

Specifically, to evaluate flammability, specimens were prepared and tested in accordance with the FMVSS 302 method. To evaluate part workability, parts were manufactured based on interior sheet parts and tested by comparing surface wrinkles and workability during the manufacture of the parts.

In other words, when the tensile strength is less than 20 kgf/3 cm as in Comparative Examples of Table 1 below and the flammability evaluation result value exceeds 102 mm/min, at least one of the first set value, the second set value, and the third set value may be corrected. The tensile strength may be determined by the thickness and structure of the regeneration layer and the physical property reinforcing layer of the regeneration composite layer, and the weight ratio of natural leather staple fibers and synthetic fibers in the regeneration layer. Therefore, when at least one set value is modified as in Examples of Table 2 below to achieve the target value from the calculated value, the set values may be corrected to reach the target values of tensile strength of equal to or greater than 20 kgf/3 cm and flammability rate of equal to or less than 102 mm/min.

TABLE 1

| | Comparative | Comparative | Comparative | Comparative | Comparative | Comparative | Comparative | Comparative |
|---|---|---|---|---|---|---|---|---|
| | Example 1 | Example 2 | Example 3 | Example 4 | Example 5 | Example 6 | Example 7 | Example 8 |
| Regeneration layer | 0.7 | 0.7 | 0.7 | 1.2 | 0.7 | 3.0 | 2.0 | 0.7 |
| thickness(mm) | | | | | | | | |
| (first set value A) | | | | | | | | |
| Physical property | 0.09 | 0.11 | 0.14 | 0.10 | 0.08 | 1.0 | 4.0 | 0.15 |
| reinforcing layer | | | | | | | | |
| thickness(mm) | | | | | | | | |
| (first set value B) | | | | | | | | |
| Natural leather staple | 70:30 | 95:5 | 95:5 | 70:30 | 95:5 | 70:30 | 70:30 | 55:45 |
| fiber (C):synthetic | | | | | | | | |
| fiber (D) weight ratio | | | | | | | | |
| (second set value) | | | | | | | | |
| Physical property | 10 (Woven | 10 (Woven | 8 (Non- | 8 (Non- | 12 (Warp | 10 (Woven | 10 (Woven | 10 (Woven |
| reinforcing layer | fabric) | fabric) | woven | woven | knit fabric) | fabric) | fabric) | fabric) |
| coefficient (third | | | fabric) | fabric) | | | | |
| set value) | | | | | | | | |
| Tensile | 17.88 | 18.69 | 18.99 | 19.50 | 16.59 | Separation of | 612.5 | 28.20 |
| strength(kgf/3 cm) | | | | | | regeneration | | |
| | | | | | | layer | | |
| | | | | | | (unmanufactured) | | |
| Flammability (mm/min) | S.E. | S.E. | S.E. | 10 | S.E. | — | 35 | 150 |
| Part workability | Good | Good | Good | Good | Good | — | Excessive | Good |
| | | | | | | | wrinkles | |
| | | | | | | | during | |
| | | | | | | | covering | |

※ S.E.: Self-Extinguishment

TABLE 2

| | Example 1 | Example 2 | Example 3 | Example 4 | Example 5 |
|---|---|---|---|---|---|
| Regeneration layer | 0.7 | 0.7 | 0.7 | 1.2 | 0.7 |
| thickness(mm) | | | | | |
| (first set value A) | | | | | |
| Physical property | 0.15 | 0.11 | 0.14 | 0.10 | 0.10 |
| reinforcing layer | | | | | |
| thickness(mm) | | | | | |
| (first set value B) | | | | | |
| Natural leather staple | 70:30 | 95:5 | 70:30 | 70:30 | 70:30 |
| fiber(C):synthetic | | | | | |
| fiber(D) weight ratio | | | | | |
| (second set value) | | | | | |
| Physical property | 10 (Woven | 12 (Warp | 8 (Non- | 10 (Woven | 12 (Warp |
| reinforcing layer | fabric) | knit fabric) | woven | fabric) | knit fabric) |
| coefficient (third | | | fabric) | | |
| set value) | | | | | |
| Tensile | 26.88 | 21.99 | 21.18 | 22.50 | 22.38 |
| strength(kgf/3 cm) | | | | | |
| Flammability(mm/min) | 15 | S.E. | S.E. | 12 | 35 |
| Part workability | Good | Good | Good | Good | Good |

What is claimed is:

1. An automotive interior part comprising:
a regeneration composite layer including a regeneration layer and a physical property reinforcing layer disposed on the regeneration layer;
a skin layer disposed on the physical property reinforcing layer of the regeneration composite layer; and
a surface-modifying layer disposed on the skin layer.

2. The automotive interior part of claim 1, wherein the regeneration layer is a layer in which natural leather staple fibers and synthetic fibers are entangled with each other.

3. The automotive interior part of claim 2, wherein the natural leather staple fibers and synthetic fibers are mixed in a weight ratio of 60 to 99:1 to 40.

4. The automotive interior part of claim 1, wherein the physical property reinforcing layer comprises at least one fiber selected from the group consisting of nylon, PET, PTT, PP, TC, linol, and cotton.

5. The automotive interior part of claim 1, wherein the physical property reinforcing layer has at least one structure selected from the group consisting of woven fabric, nonwoven fabric, warp knit fabric, and circular knit fabric.

6. The automotive interior part of claim 1, wherein the regeneration layer has a thickness in a range of 0.5 mm to 2.0 mm, and the physical property reinforcing layer has a thickness in a range of 0.1 mm to 3.0 mm.

7. The automotive interior part of claim 1, wherein the regeneration composite layer has a thickness in a range of 0.6 mm to 5.0 mm.

8. The automotive interior part of claim 1, wherein the skin layer comprises at least one material selected from the group consisting of water-dispersible polyurethane (PU), solvent-free high solids, solvent-free polyurethane (PU), solvent-type polyurethane (PU), acrylic polyurethane resin, thermoplastic polyurethane (TPU), and silicone.

9. The automotive interior part of claim 1, wherein the skin layer has a thickness in a range of 0.01 mm to 0.5 mm.

10. The automotive interior part of claim 1, wherein the surface-modifying layer comprises a polyurethane resin and a gloss control agent.

11. The automotive interior part of claim 1, wherein a wet application amount of the surface-modifying layer is equal to or less than 3.0 g/ft².

12. The automotive interior part of claim 1, wherein the automotive interior part is used for at least one purpose selected from the group consisting of automotive seats, door trims, consoles, crush pads, and steering wheels.

13. A method of manufacturing an automotive interior part, the method comprising:
preparing a regeneration layer;
preparing a regeneration composite layer by laminating a physical property reinforcing layer on the regeneration layer;
preparing an initial skin layer on release paper;
preparing a laminate including a skin layer by laminating, on the physical property reinforcing layer of the regeneration composite layer, the initial skin layer on the release paper, followed by performing curing;
removing the release paper; and
coating a surface-modifying layer on the skin layer of the laminate.

14. The method of claim 13, wherein the preparing of the regeneration layer comprises:
preparing an initial regeneration layer by entangling natural leather staple fibers and polyester fibers with each other;
performing primary drying to primarily remove moisture from the initial regeneration layer;
removing hexavalent chromium from the initial regeneration layer from which moisture has been primarily removed; and
performing secondary drying to secondarily remove moisture from the initial regeneration layer from which chromium has been removed.

15. The method of claim 13, wherein the initial skin layer has a thickness in a range of 0.01 mm to 0.5 mm.
